(19) United States
(12) Patent Application Publication
(10) Pub. No.: US 2003/0065593 A1
(43) Pub. Date: Apr. 3, 2003

(54) Business activity control system

(76) Inventor: Masako Tabei, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/247,448

(22) Filed: Sep. 20, 2002

(30) Foreign Application Priority Data
Oct. 1, 2001 (JP) 2001-305415

(51) Int. Cl. G06F 17/60

(52) U.S. Cl. 705/32

(57) ABSTRACT

A business activity control system is provided which makes it easy for salesmen to report the results of their sales activities and to input them into a computer. A hand-written report is transmitted through facsimile to a FAX-OCR server to digitalize the data. The data is inputted into a computer, which outputs various control documents.

### BACKGROUND OF THE INVENTION

The present invention relates to a system for efficiently reporting and controlling the results of business activities.

Among the business activities, visiting a customer and explaining and persuading directly is the most effective method. But it is troublesome and time-consuming for a salesman to prepare a business report or visit report and it is difficult to report quickly. E.g. in inviting into franchise activity, it is difficult to control the business activity of salesmen by means of a computer.

An object of the present invention is to provide a business activity control system which makes it easy for a salesman to report his business activity and input the data on business activity into a computer.

### SUMMARY OF THE INVENTION

According to this invention, there is provided a business activity control system comprising means for transmitting in the form of images business activity reports which include results of business visits that are distinguished one from anther by telephone numbers, visiting times, number of visits and a plurality of symbols, means for receiving and digitizing the data, and means for computing/analyzing the digitized data.

The symbols indicate conclusion of contract, promising, continuation of business activities, and discontinuance. The means for receiving and digitizing said data is preferably a Fax-OCR.

The computation/analyzation determines prospective customers information that is known from the number and change of said symbols in time sequence, or a correlation between visiting times, the number of visits and expenses and the symbols.

### BRIEF DESCRIPTION OF THE DRAWINGS

Other features and objects of the present invention will become apparent from the following description made with reference to the accompanying drawings, in which:

FIG. 1 is a schematic diagram showing a business activity control system of this invention; and

FIG. 2 is a plan view showing an example of a business activity report.

### DETAILED DESCRIPTION OF THE PREFERRED EMBODIMENT

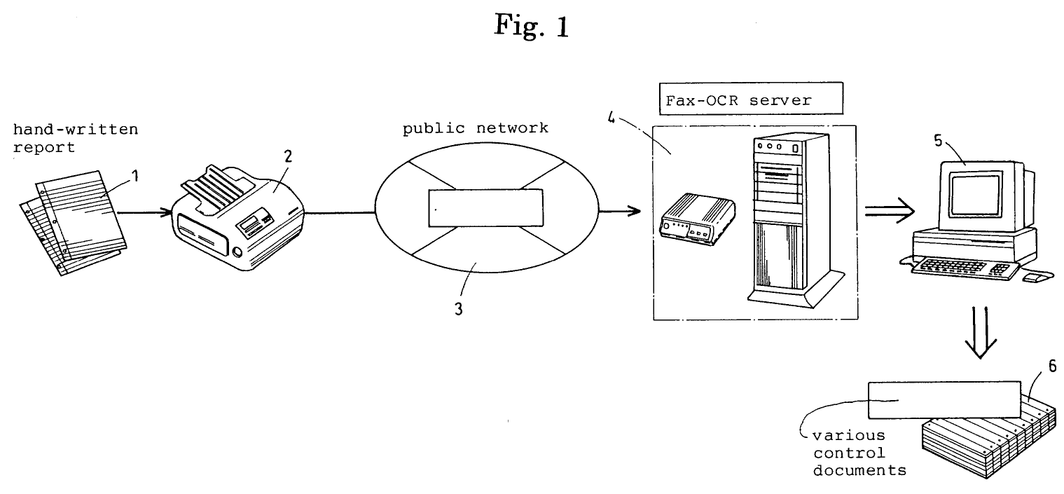

An embodiment of the business activity control system according to this invention will be described with reference to the accompanying drawings. FIG. 1 is a schematic view showing the business activity control system. As shown, a salesman prepares a hand-written business activity report 1 and transmits it by a facsimile 2 to a FAX-OCR server 4 through a public network 3. The FAX-OCR server 4 converts the image data to digital information and inputs it to a computer 5. Based on the data, the computer 5 performs various operations and outputs various control documents 6.

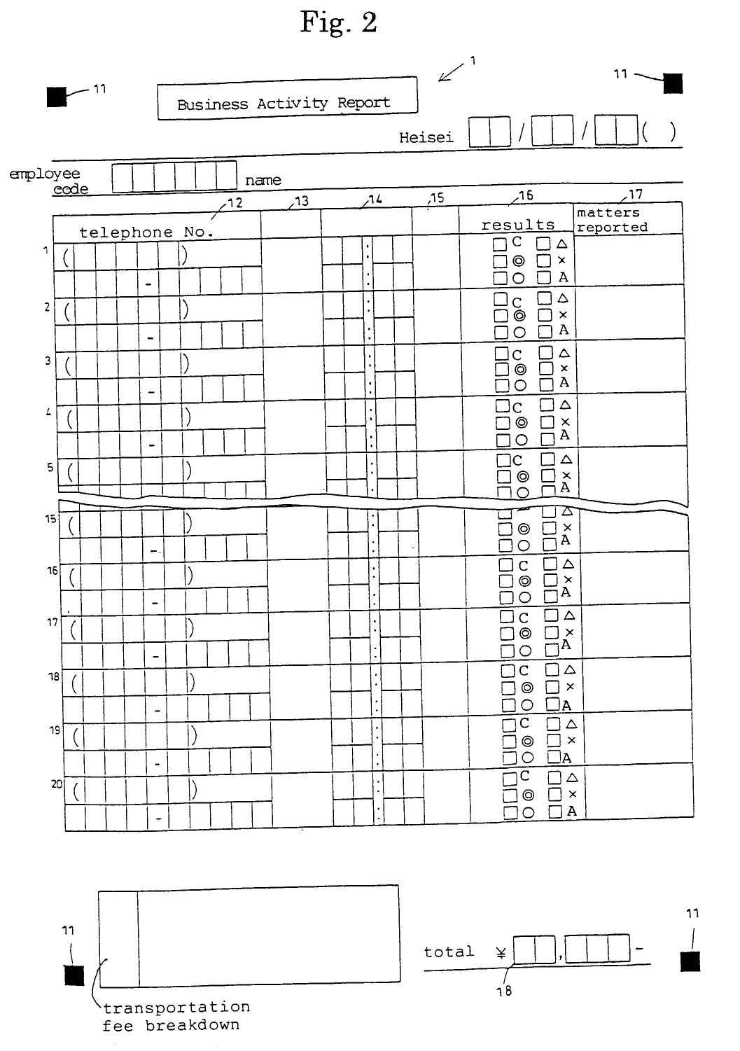

As shown in FIG. 2, the business activity report 1 is provided with endpoints 11 which serve as references for reading by the Fax-OCR server 4, and has columns for customer phone numbers 12, customer names 13, visiting times 14, numbers of visits 15, results of visit 16, item to be reported 17 and expenses 18 including transportation expenses. While the customer names 13 and the items to be reported 17 are inputted in the form of images, the customer names 13 can be found from the telephone numbers in the prospective customer file which is prepared beforehand. Other items 12, 14, 15, 16, 18 can be digitized as they are.

The result of visits 16 is indicated by marking one of a plurality of symbols. “C” indicates contract concluded, “⊚” does promising, “Δ” indicates continuation of business, “X” means discontinuance, and “A” means absence. It is preferable to determine measures according to these symbols. For example, in the case of “⊚”, the salesman should talk to his superior after coming back to the office and arrange a schedule for visiting the customer again with the superior within a week. In the case of “ο”, which means a good chance of reaching an agreement, the salesman should draw up a proposition and revisit the customer with his superior within a week. In the case of “Δ”, the day for a revisit is entered into the computer 5 to notify the salesman of the day when it comes close. The symbols showing the results of visit may be arbitrarily selected. Also, business activities corresponding to the symbols may also be selected as necessary.

By analyzing the contents of the business activity report 1 by the computer 5, various beneficial materials are obtainable, e.g. the change in the above symbols in time sequence and prospective customer control information such as the number of symbols “ο” among a total number of the customers visited, and the percentage of the number of customers that concluded the contract relative to the number of symbols “ο”. Besides, behavior control information is obtained which represents the relation between the result of visit and items 14, 15 and 18 such as the number of visits per day, average meeting time per customer, average number of visits until the contract is made, expenses including transportation expenses, and the relation between the results of visits and expenses. These are outputted as various control documents 6 such as customer follow-up control ledgers, individual salesmen's control daily reports and expense reports.

According to this invention, because the business activity reports are sent by facsimile and digitally converted by an OCR server, it is possible to save the trouble of inputting the business activity reports. Also, because the customers are identified by the phone numbers and the results of business activities are symbolized, salesmen can save the trouble of entering the business activity reports and can efficiently analyze the business activities on the computer.

What is claimed is:

1. A business activity control system comprising means for transmitting in the form of images business activity reports which include results of business visits that are distinguished one from anther by telephone numbers, visiting times, number of visits and a plurality of symbols, means for receiving and digitizing said data, and means for computing/analyzing the digitized data.

2. A business activity control system as claimed in claim 1 wherein said symbols indicate conclusion of contract, promising, continuation of business activities, or discontinuance.

3. A business activity control system as claimed in claim 1 or 2 wherein the means for receiving and digitizing said data is a Fax-OCR.

4. A business activity control system as claimed in any of claims 1-3 wherein said computation/analyzation is to obtain prospective customer information that is determined from the number and change of said symbols in time sequence.

5. A business activity control system as claimed in any of claims 1-4 wherein said computation/analyzation comprises finding a correlation between said symbols and visiting times, number of visits and expenses.
